(19) United States
(12) Patent Application Publication
(10) Pub. No.: US 2026/0203595 A1
(43) Pub. Date: Jul. 16, 2026

(54) LEARNING APPARATUS, FEATURE VALUE CONVERSION APPARATUS, LEARNING METHOD AND PROGRAM

(71) Applicant: NTT Inc., Tokyo (JP)

(72) Inventors: Ko TANAKA, Musashino-shi (JP); Hirokazu KAMEOKA, Musashino-shi (JP); Takuhiro NANEKO, Musashino-shi (JP); Shogo SEKI, Musashino-shi (JP)

(73) Assignee: NTT Inc., Tokyo (JP)

(21) Appl. No.: 19/132,485

(22) PCT Filed: Dec. 22, 2022
(86) PCT No.: PCT/JP2022/047387

§ 371 Date: May 23, 2025

(51) Int. Cl. G06N 3/096; G10L 15/02; G10L 15/06; G10L 21/007; G10L 25/30

(52) U.S. Cl. CPC G06N 3/096; G10L 15/02; G10L 15/063; G10L 21/007; G10L 25/30

(57) ABSTRACT

A learning device includes a teacher model unit that includes a first encoder and a first decoder including a first recurrent neural network, a student model unit that includes a second encoder and a second decoder including a second recurrent neural network, and a learning control unit that performs learning of the teacher model unit by using a sequence-to-sequence machine learning method and performs learning of the student model unit by using a knowledge distillation method from the teacher model unit. A feature conversion device includes an acquisition unit that acquires a student model unit, and a converter that converts an input feature sequence into a target feature sequence

### TECHNICAL FIELD

The present invention relates to a learning apparatus, a feature conversion apparatus, a learning method and a program.

### BACKGROUND ART

Voice conversion is a technique for converting non-linguistic and paralinguistic components (for example, the speaker properties, the speaking style, and the like) of an input voice sequence while preserving context information of the input voice sequence and is applied to various tasks such as speaker property conversion, speech assistance, voice enhancement, and accent conversion. The problem of voice conversion can be formulated as a problem of regression analysis of estimating a mapping function for features of a target voice sequence (voice sequence after conversion) based on the features of the input voice sequence (voice sequence before conversion).

In recent years, sequence-to-sequence (S2S) machine learning has shown to be highly effective in tasks such as machine translation, voice recognition, and text-to-voice synthesis, and has started to be applied to voice conversion (see Non Patent Document 1). Furthermore, voice conversion using a Gaussian mixture model (GMM) is widely used because of high effectiveness and versatility.

### CITATION LIST

### Non Patent Document

Non Patent Document 1: J. Zhang, Z. Ling, L. Liu, Y. Jiang, and L. Dai, “Sequence-to-sequence acoustic modeling for voice conversion,”, IEEE/ACM Transactions on Audio, Speech, and Language Processing, vol. 27, no. 3, pp. 631-644, 2019.

### SUMMARY OF INVENTION

### Technical Problem

In S2S machine learning, by using an encoder and a decoder including an attention mechanism, it is possible to learn conversion rules that reflect the long-term dependencies between the input voice sequence and the target voice sequence. However, since the encoder has a non-causal layer, the entirety of the input voice sequence (sentence) is obtained, and then the conversion processing on the input voice sequence can be performed.

FIG. 8 is a diagram illustrating an example of a non-causal layer and an example of a causal layer. A non-causal layer 10 performs sequential conversion processing on an input feature sequence 11 and outputs a converted feature sequence 12. Here, the non-causal layer 10 may perform sequential conversion processing on a future input voice sequence by prefetching the input feature sequence 11.

On the other hand, a causal layer 13 performs sequential conversion processing on an input feature sequence 14 and outputs a converted feature sequence 15. Here, since the causal layer 13 does not prefetch the input feature sequence 14, the sequential conversion processing is not performed on the future input voice sequence.

In a case where the feature of streaming voice data is subjected to the sequential conversion processing with a low delay, the delay of the target audio sequence increases according to the prefetch amount of the future input voice sequence. Waiting for an input of the entirety of the input voice sequence is a major barrier from the viewpoint of smooth voice communication in daily life.

In addition, a voice generated based on the target sound sequence is delayed and fed back to an auditory system, so that the voice may sound unnatural. The influence of such a feedback delay also needs to be considered. Therefore, in the task of voice conversion, it is necessary to perform the sequential conversion processing with a low delay of several tens ms or less, for example.

In the scenario of no prefetch or minimal prefetch in the S2S machine learning, it is likely that the sequential conversion processing on the feature with a low delay can be realized by an approach based on a recurrent neural network (RNN) instead of an approach based on “convolution/transformer” (Reference Document 1: Hirokazu Kameoka, Kou Tanaka, and Takuhiro Kaneko, “FastS2S-VC: Streaming non-autoregressive sequence-to-sequence voice conversion,” arXiv preprint arXiv: 2104. 06900, 2021.) (Reference Document 2: Xie Chen, Yu Wu, Zhenghao Wang, Shujie Liu, and Jinyu Li, “Developing real-time streaming transformer transducer for speech recognition on large-scale dataset,” in ICASSP, 2021, pp. 5904-5908.).

Layers of the recurrent neural network can hold time-series information. On the other hand, in a machine learning model based on “convolution/transformer”, a deep architecture is required in order to hold time-series information. Furthermore, if the non-causal layer of the encoder is merely replaced with the causal layer, a large delay may occur in the target voice sequence.

FIG. 9 is a diagram illustrating a comparative example of an attention matrix. An attention matrix 16 is an attention matrix generated using a machine learning model of a standard encoder and decoder. An attention matrix 17 is an attention matrix generated using a machine learning model of an encoder and a decoder in which a non-causal layer is replaced with a causal layer. In FIG. 9, the steps in the attention matrix 17 are shifted by about 300 ms. The shift of the steps in the attention matrix 17 directly increases the delay amount of the sequential conversion processing of the streaming voice data.

Note that an occurrence of such a delay has also been reported as a problem in voice recognition (Reference Document 3: Gakuto Kurata and George Saon, “Knowledge distillation from offline to streaming RNN transducer for end-to-end speech recognition,” in INTERSPEECH, 2020, pp. 2117-2121.).

A uni-directional recurrent neural network has a characteristic of accurately capturing a time-frequency structure. In a case where the machine learning model is learned from zero without any guidance, due to such a characteristic, the uni-directional recurrent neural network may be learned so that the current target voice sequence is generated after the future input voice sequence is minimally prefetched.

In a learning stage of the machine learning model having the uni-directional recurrent neural network, such a delay is canceled by the attention mechanism. On the other hand, in a test of the machine learning model having the uni-directional recurrent neural network, the attention matrix is forcibly diagonalized, so that such a delay is not canceled. In a case where the delay is not canceled, the overall delay amount increases. As described above, in some cases, it is not possible to perform the sequential conversion processing on the feature with a low delay.

In view of the above circumstances, an object of the present invention is to provide a learning device, a feature conversion device, a learning method, and a program capable of performing sequential conversion processing on a feature with a low delay.

### Solution to Problem

According to an aspect of the present invention, a learning device includes a teacher model unit that includes a first encoder and a first decoder including a first recurrent neural network, a student model unit that includes a second encoder and a second decoder including a second recurrent neural network, and a learning control unit that performs learning of the teacher model unit by using a sequence-to-sequence machine learning method and performs learning of the student model unit by using a knowledge distillation method from the teacher model unit.

According to another aspect of the present invention, a feature conversion device includes an acquisition unit that acquires a student model unit from a learning device including a teacher model unit that includes a first encoder and a first decoder including a first recurrent neural network, the student model unit that includes a second encoder and a second decoder including a second recurrent neural network, and a learning control unit that performs learning of the teacher model unit by using a sequence-to-sequence machine learning method and performs learning of the student model unit by using a knowledge distillation method from the teacher model unit, and a converter that converts an input feature sequence into a target feature sequence using the student model unit.

According to still another aspect of the present invention, there is provided a learning method performed by a learning device. The learning method includes a step of performing learning of a teacher model unit that includes a first encoder and a first decoder including a first recurrent neural network by using a sequence-to-sequence machine learning method, and a step of performing learning of a student model unit that includes a second encoder and a second decoder including a second recurrent neural network by using a knowledge distillation method from the teacher model unit.

According to still yet another aspect of the present invention, there is provided a program causing a computer to execute a procedure of performing learning of a teacher model unit that includes a first encoder and a first decoder including a first recurrent neural network by using a sequence-to-sequence machine learning method, and a procedure of performing learning of a student model unit that includes a second encoder and a second decoder including a second recurrent neural network by using a knowledge distillation method from the teacher model unit.

### Advantageous Effects of Invention

According to the present invention, it is possible to perform sequential conversion processing on a feature with a low delay.

### BRIEF DESCRIPTION OF DRAWINGS

FIG. 1 A diagram illustrating a configuration example of a feature conversion system in an embodiment.

FIG. 2 A diagram illustrating a configuration example of a learning device in the embodiment.

FIG. 3 A flowchart illustrating an operation example of the learning device in the embodiment.

FIG. 4 A flowchart illustrating an operation example of a feature conversion device in the embodiment.

FIG. 5 A diagram illustrating an example of a subjective evaluation result related to sound quality in each embodiment.

FIG. 6 A diagram illustrating an example of a subjective evaluation result related to speaker similarity in each embodiment.

FIG. 7 A diagram illustrating a hardware configuration example of the feature conversion system in each embodiment.

FIG. 8 A diagram illustrating an example of a non-causal layer and an example of a causal layer.

FIG. 9 A diagram illustrating a comparative example of an attention matrix.

### DESCRIPTION OF EMBODIMENTS

Embodiments of the present invention will be described in detail with reference to the drawings.

In the following, knowledge distillation (KD), known as teacher-student framework, is applied to an S2S model based on recurrent neural networks. As a result, the sequential conversion of the feature is realized with high quality while suppressing increase in the delay amount.

### First Embodiment

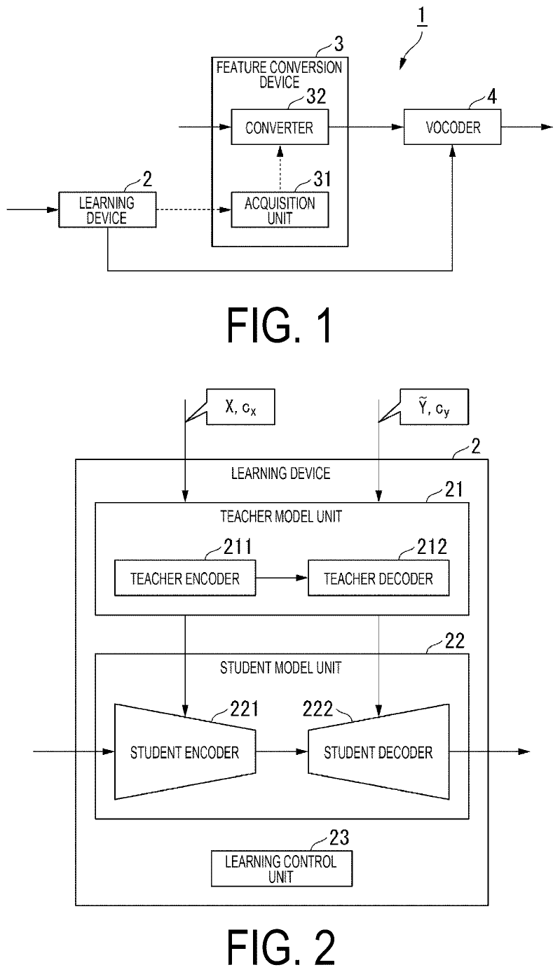

FIG. 1 is a diagram illustrating a configuration example of a feature conversion system 1 in an embodiment. The feature conversion system 1 is a system that sequentially converts an input feature sequence into a target feature sequence. The feature sequence is, for example, a voice sequence. For example, the feature conversion system 1 converts the non-language and the paralinguistic (for example, the speaker properties and the speaking style) of an input voice sequence into the non-language and the paralinguistic of a target voice sequence while holding the linguistic information (utterance sentence) of the input voice sequence.

The feature conversion system 1 includes a learning device 2, a feature conversion device 3, and a vocoder 4. The feature conversion device 3 includes an acquisition unit 31 and a converter 32.

The learning device 2 includes a teacher model unit and a student model unit. The teacher model unit and the student model unit have a recurrent neural network. In a learning stage, the learning device 2 performs machine learning in which knowledge distillation is applied to an S2S voice conversion model (recurrent network model) based on the recurrent neural network. The student model unit of the learning device 2 generates a target voice sequence based on an input voice sequence. The vocoder 4 may output a voice based on the target voice sequence generated by the student model unit of the learning device 2.

In an inference stage after the learning stage, the acquisition unit 31 acquires the learned student model unit (student encoder and student decoder) from the learning device 2. The converter 32 converts the input voice sequence (input feature sequence) in the converter 32 into the target voice sequence (target feature sequence) using the learned student model unit. The vocoder 4 may output a voice based on the target voice sequence generated by the converter 32.

FIG. 2 is a diagram illustrating a configuration example of the learning device 2 in the embodiment. The learning device 2 includes a teacher model unit 21 and a student model unit 22. The student model unit 22 includes a student encoder 221 and a student decoder 222 as a student model in knowledge distillation.

In the following, the input feature sequence (input voice sequence) is represented by, for example, “X=[x₁, . . . , x_{I}]”. The target feature sequence (target voice sequence) is represented by, for example, “Y=[y₁, . . . , y_{J}]”. The sequence length of the input feature sequence “X” and the sequence length of the feature sequence “Y” of the target voice may be different. In addition, the input feature sequence “X” may be represented in the form of, for example, a logarithmic Mel spectrogram.

The teacher model unit 21 includes a teacher encoder 211 and a teacher decoder 212 as a teacher model (S2S model). The teacher model is a voice conversion model (recurrent network model) of S2S based on the recurrent neural network. The teacher model unit 21 performs machine learning of the teacher model that converts the input feature sequence into the target feature sequence by using the teacher encoder 211 and the teacher decoder 212 having the recurrent network model.

The teacher encoder 211 “f_{Enc}” of the teacher model unit 21 acquires an input feature sequence (input voice sequence) “X” and an input speaker vector “cₓ” (speaker information). The teacher encoder 211 “f_{Enc}” of the teacher model unit 21 generates an encoded input feature sequence “Zₓ” as shown in Expression (1) based on the input feature sequence “X” and the input speaker vector “cₓ”.

$$[ Math . 1 ]$$

$${Z}_{x} = {f}_{Enc} ( X , {c}_{x} ) . \qquad ( 1 )$$

In the following, a symbol added above a character in a mathematical expression or a function (referred to as a “mathematical expression or the like” below) is written before the character. For example, a symbol “~” added to a character in a mathematical expression or the like is described as “(~)Y” before the character “Y” in the following. For example, a symbol “\hat{ }” added to a character in a mathematical expression or the like is described as “\hat{ }Y” before the character “Y” in the following.

The teacher decoder 212 “f_{Dec}” of the teacher model unit 21 generates a prediction result “\hat{ }Y=[\hat{ }y₁, . . . , \hat{ }yⱼ]” of the target feature sequence as shown in Expression (2), based on the past target feature sequence “(~)Y=[y₀, (~)y₁, . . . , (~)yⱼ₋₁]”, the target speaker vector “c_{y}”, and the encoded input feature sequence “Zₓ”.

$$[ Math . 2 ]$$

$$\hat{Y} , A = {f}_{Dec} ( {Z}_{x} , \tilde{Y} , {c}_{y} ) . \qquad ( 2 )$$

Here, each column of “A” represents a probability distribution (attention matrix) that describes a correspondence relationship between the time of the input feature sequence “Zₓ” with respect to the decoder of the teacher model unit 21 and the time of the prediction result “\hat{ }Y” of the target feature sequence generated by the decoder of the teacher model unit 21. “y₀” represents a zero vector. In the learning stage of the teacher model, “[(~)y₁, . . . , (~)yⱼ₋₁]” in the past target feature sequence is “[y₁, . . . , yⱼ₋₁]”. In a test of the teacher model after the learning stage, [(~)y₁, . . . , (~)yⱼ₋₁] in the past target feature sequence is [\hat{ }y₁, . . . \hat{ }yⱼ₋₁].

An objective function “L_{Teacher}” minimized in the learning stage of the teacher model is represented as Expression (3) by using the norm.

$$[ Math . 3 ]$$

$${ℒ}_{Teacher} = {‖ \hat{Y} - Y ‖}_{1} . \qquad ( 3 )$$

The structure of the student encoder 221 “f_{DistEnc}” in the student model unit 22 may be the same as or different from the structure of the encoder “f_{Enc}” of the teacher model unit 21 except for a part of the structure. Here, the part of the structure is a structure capable of sequential conversion processing, and is a structure in which a non-causal convolution layer and a bi-directional long short term memory (LSTM) layer are replaced with a causal convolution layer and a uni-directional long short term memory layer. Furthermore, the structure of the student decoder 222 “f_{DistDec}” in the student model unit 22 may be the same as or different from the structure of the decoder “f_{Dec}” in the teacher model unit 21.

A learning control unit 23 controls the operation of each functional unit of the learning device 2. In a first embodiment (Approach-1), already in the learning stage of the student model unit 22, the structure of the decoder “f_{Dec}” of the teacher model unit 21 is a structure in which sequential conversion processing can be already performed.

In the learning stage of the student model unit 22, the learning control unit 23 performs learning processing (knowledge distillation) of the student encoder 221 “f_{DistEnc}”. The model parameter of the student decoder 222 “f_{DistDec}” is initialized by the model parameter of the decoder “f_{Dec}” of the teacher model unit 21. Furthermore, the initialized model parameter of the student decoder 222 “f_{DistDec}” is fixed in the learning (weight freezing) of the student model unit 22. As a result, the decoder of the teacher model unit 21 is used as the student decoder 222.

In the first embodiment, a voice data set of a target feature sequence “(~)Y” of a speaker vector “c_{y}” different from an input feature sequence “X” of a speaker vector “C” is used for learning of the student encoder 221.

The student encoder 221 “f_{DistEnc}” generates an encoded input feature sequence “Z′ₓ” based on the input feature sequence “X” and the speaker vector “cₓ”. The encoded input feature sequence “Z″ₓ” is represented by Expression (4).

$$[ Math . 4 ]$$

$${Z}_{x}^{′} = {f}_{DistEnc} ( X , {c}_{x} ) , \qquad ( 4 )$$

The sequence length of the input feature sequence “X” and the sequence length of the feature sequence “(~)Y” of the target voice may be different. Therefore, attention freezing of the attention matrix is used together with the weight freezing. The attention matrix “A” generated by the teacher model unit 21 is used for the encoded input feature sequence “Z′ₓ” as in Expression (5).

$$[ Math . 5 ]$$

$${Y}^{′} = {f}_{Dec}^{⋆} ( {Z}_{x}^{′} A , \tilde{Y} , {c}_{y} ) , \qquad ( 5 )$$

Here, the star in the expression represents attention freezing of the attention matrix (omission of the attention mechanism). Furthermore, an objective function “L_{Student}” minimized in the learning stage of the student model unit 22 is represented as Expression (6) by using the norm.

$$[ Math . 6 ]$$

$${ℒ}_{Student} = ‖ {Y}^{′} - Y {‖}_{2} , \qquad ( 6 )$$

Next, an operation example of the feature conversion system 1 will be described.

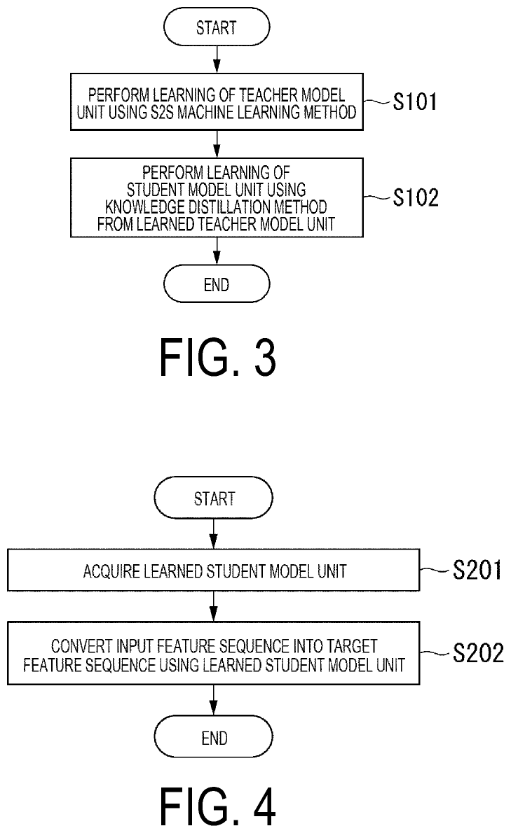

FIG. 3 is a flowchart illustrating the operation example of the learning device 2 in the embodiment. In the learning stage of the student model unit 22, the learning control unit 23 performs learning of the teacher model unit 21 using an S2S machine learning method (Step S101). The learning control unit 23 performs learning of the student model unit 22 using a knowledge distillation method from the learned teacher model unit 21 (Step S102).

FIG. 4 is a flowchart illustrating an operation example of the feature conversion device 3 in the embodiment. In the inference stage after the learning stage of the student model unit 22, the acquisition unit 31 acquires the learned student model unit 22 (Step S201). The converter 32 converts the input feature sequence in the converter 32 into the target feature sequence using the learned student model (Step S202).

As described above, the teacher model unit 21 includes the teacher encoder 211 (first encoder) and the teacher decoder 212 (first decoder) including the first recurrent neural network (first RNN). The student model unit 22 includes the student encoder 221 (second encoder) and the student decoder 222 (second decoder) including the second recurrent neural network (second RNN).

The learning control unit 23 performs learning of the teacher model unit 21 by using a sequence-to-sequence (S2S) machine learning method. Here, the learning control unit 23 performs learning of the teacher model unit 21 to minimize the objective function “L_{Teacher}”. The teacher decoder 212 “f_{Dec}” of the teacher model unit 21 generates the attention matrix “A” and the prediction result “\hat{ }Y” of the target feature sequence.

The learning control unit 23 performs learning of the student model unit 22 using a knowledge distillation method from the teacher model unit 21. Here, the learning control unit 23 performs learning of the student model unit 22 to minimize the objective function “L_{Student}”.

The student encoder 221 generates the encoded input feature sequence “Z′ₓ” based on a first speaker vector “cₓ” and the input feature sequence “X” of the speaker of the first speaker vector. The model parameter of the student decoder 222 is initialized and fixed by the model parameter of the teacher decoder 212. The student decoder 222 generates a second target feature sequence “Y′” of a speaker of a second speaker vector based on the second speaker vector “c_{y}”, a first target feature sequence “(~)Y” of the speaker of the second speaker vector, the attention matrix “A”, and the encoded input feature sequence “Z′ₓ”.

As a result, it is possible to perform sequential conversion processing on a feature with a low delay.

### Second Embodiment

A second embodiment (Approach-2) is different from the first embodiment in that machine learning of the student encoder is performed based on self-supervised learning. In the second embodiment, differences from the first embodiment will be mainly described.

In the second embodiment, already in the learning stage of the student model unit 22, the structure of the decoder “f_{Dec}” of the teacher model unit 21 is a structure in which sequential conversion processing can be performed. In the learning stage of the student model unit 22, the learning control unit 23 performs learning processing of the student encoder 221 “f_{DistEnc}”. The model parameter of the student decoder 222 “f_{DistDec}” is initialized by the model parameter of the decoder “f_{Dec}” of the teacher model unit 21. Furthermore, the initialized model parameter of the student decoder 222 “f_{DistDec}” is fixed in the learning stage (weight freezing) of the student model unit 22. As a result, the decoder of the teacher model unit 21 is used as the student decoder 222.

The learning control unit 23 performs self-supervised learning such as learning of an auto encoder for learning of the student model unit 22. The student encoder 221 “f_{DistEnd}” generates an encoded input feature sequence “Z′_{y}” based on the target feature sequence “Y” (the input feature sequence in the second embodiment) and the input speaker vector “c_{y}” as shown in Expression (7).

$$[ Math . 7 ]$$

$${Z}_{y}^{′} = {f}_{DistEnc} ( Y , {c}_{y} ) , \qquad ( 7 )$$

The student decoder 222 “f″_{Dec}” generates the target feature sequence “Y′” (target feature sequence in the second embodiment) as shown in Expression (8), based on the target feature sequence “(~)Y” (context information), the input speaker vector “c_{y}”, and the encoded input feature sequence “Z′_{y}”.

$$[ Math . 8 ]$$

$${Y}^{′} = {f}_{Dec}^{⋆} ( {Z}_{y}^{′} , \tilde{Y} , {c}_{y} ) . \qquad ( 8 )$$

Here, the star in the expression represents attention freezing of the attention matrix (omission of the attention mechanism). If the machine learning of the teacher model unit 21 is successful in the learning stage of the teacher model unit 21, the input to the student decoder 222 is assumed to be the separated features (the input feature sequence “Z′_{y}” (extracted context information) extracted by the student encoder 221 and the speaker vector “c_{y}”). Therefore, by the self-supervised learning in the second embodiment, the student encoder 221 serves not as a functional unit that simply compresses the input feature sequence but as a functional unit (functional unit that extracts the context information from the input feature sequence) that effectively removes the speaker vector “c_{y}” from the input feature sequence (target feature sequence “Y”).

As described above, the student encoder 221 “f″_{DistDec}” generates the encoded target feature sequence “Z′ₓ” based on the speaker vector “cₓ” and the target feature sequence “X” of the speaker of the speaker vector. The model parameter of the student decoder 222 is initialized and fixed by the model parameter of the teacher decoder 212. The student decoder 222 “f″_{Dec}” generates the second target feature sequence “Y′” of the speaker of the speaker vector based on the speaker vector “c_{y}”, the first target feature sequence “(~)Y” of the speaker of the speaker vector, and the encoded target feature sequence “Z′_{y}”.

As a result, it is possible to perform sequential conversion processing on a feature with a low delay.

### Third Embodiment

A third embodiment (Approach-3) is different from the first embodiment and the second embodiment in that machine learning is also performed for the student decoder 222. In the third embodiment, differences from the first embodiment and the second embodiment will be mainly described.

In the third embodiment, the learning control unit 23 performs both learning of the student encoder 221 “f_{DistEnc}” and learning of the student decoder 222 “f_{DistDec}”.

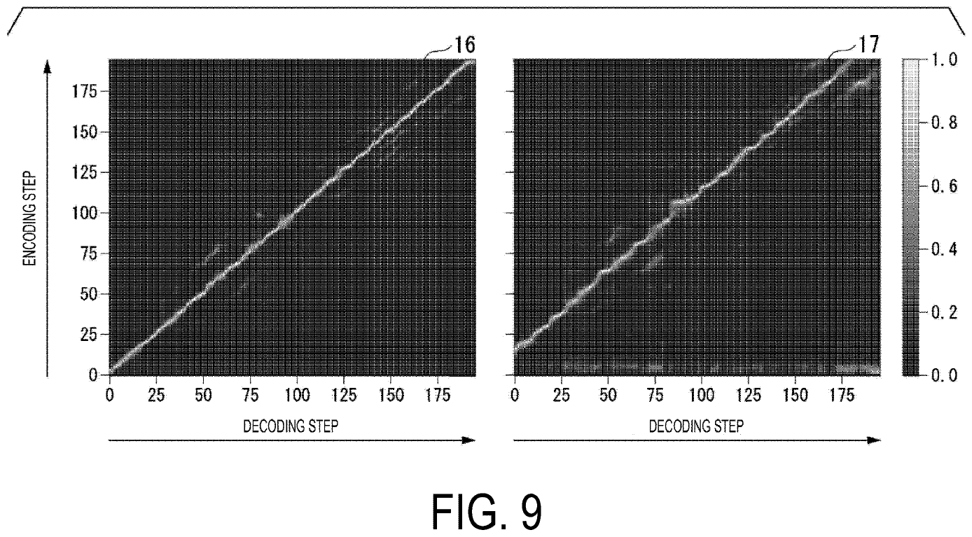

Furthermore, in the approach in which all model parameters of the student model unit 22 are learned after the non-causal encoder of the student model unit 22 is replaced with the causal encoder, the attention matrix may deviate as illustrated in FIG. 9. Therefore, in the third embodiment, learning (knowledge distillation) of the student model unit 22 is performed using the attention matrix generated by the teacher model unit 21 as a guide.

The student decoder 222 “f_{DistDec}” generates the prediction result “Y′” of the target feature sequence as in Expression (9), based on the target feature sequence “(~)Y” (context information), the input speaker vector “c_{y}”, the input feature sequence “Z′ₓ” encoded by the student encoder 221, and the attention matrix “A” generated by the teacher model unit 21.

$$[ Math . 9 ]$$

$${Y}^{′} = {f}_{DistDec}^{⋆} ( {Z}_{x}^{′} A , \tilde{Y} , {c}_{y} ) . \qquad ( 9 )$$

Here, the star in the expression represents attention freezing of the attention matrix (omission of the attention mechanism). Furthermore, the sequence length of the input feature sequence “(~)Y” is changed to the sequence length of the prediction result “Y′” of the target feature sequence by the attention matrix “A”.

As described above, the teacher decoder 212 of the teacher model unit 21 generates the attention matrix “A”. The student encoder 221 generates the encoded input feature sequence “Z′ₓ” based on a first speaker vector “cₓ” and the input feature sequence “X” of the speaker of the first speaker vector. The student decoder 222 generates a second target feature sequence “Y′” of a speaker of a second speaker vector based on the second speaker vector “c_{y}”, a first target feature sequence “(~)Y” of the speaker of the second speaker vector, the attention matrix “A”, and the encoded input feature sequence “Z′ₓ”.

As a result, it is possible to perform sequential conversion processing on a feature with a low delay.

### Fourth Embodiment

A fourth embodiment (Approach-4) is different from the third embodiment in that machine learning of the student model unit 22 is performed based on an attention mechanism (attention distillation loss). In the fourth embodiment, differences from the third embodiment will be mainly described.

In the fourth embodiment, the learning control unit 23 performs both learning of the student encoder 221 “f_{DistEnc}” and learning of the student decoder 222 “f_{DistDec}”.

In the fourth embodiment, the learning (attention distillation) of the attention mechanism of the student model unit 22 is performed based on the loss of an attention matrix “A′” generated by the student decoder 222 with respect to the attention matrix “A” generated by the teacher model unit 21.

The student decoder 222 “f_{DistDec}” generates the prediction result “Y′” of the target feature sequence and the attention matrix “A′” as in Expression (10), based on the target feature sequence “(~)Y” (context information), the input speaker vector “c_{y}”, and the input feature sequence “Z′ₓ” encoded by the student encoder 221.

$$[ Math . 10 ]$$

$${Y}^{′} , {A}^{′} = {f}_{DistDec} ( {Z}_{x}^{′} , \tilde{Y} , {c}_{y} ) , \qquad ( 10 )$$

Each column of the attention matrix “A′” represents a probability distribution that describes a correspondence relationship between the time of the input feature sequence “Z′ₓ” with respect to the student decoder 222 and the time of the prediction result “Y′” of the target feature sequence generated by the student decoder 222.

As a loss term of the attention distillation, Kullback-Leibler Divergence (KLD) (KL information amount) “L_{AttKLD}” is represented by Expression (11).

$$[ Math . 11 ]$$

$${ℒ}_{AttKLD} = {\sum }_{j} {𝒟}_{K L} ( {a}_{j} \vert \vert {a}_{j}^{′} ) , \qquad ( 11 )$$

Here, “aⱼ” represents an attention vector in the j-th row of the attention matrix “A”. In addition, “a′ⱼ” represents an attention vector in the j-th row of the attention matrix “A′”.

As described above, the teacher decoder 212 of the teacher model unit 21 generates the first attention matrix “A”. The student encoder 221 “f_{DistEnc}” generates the encoded input feature sequence “Z′ₓ” based on a first speaker vector “cₓ” and the input feature sequence “X” of the speaker of the first speaker vector. The student decoder 222 “f_{DistDec}” generates the second target feature sequence “Y′” of the speaker of the second speaker vector and the second attention matrix “A′” based on the second speaker vector “c_{y}”, the first target feature sequence “(~)Y” of the speaker of the second speaker vector, and the encoded input feature sequence “Z′ₓ”. The learning control unit 23 obtains a loss “L_{AttKLD}” based on the first attention matrix “A” and the second attention matrix “A′”.

As a result, it is possible to perform sequential conversion processing on a feature with a low delay.

### (Effects)

Listening experiments on voice quality and speaker similarity were performed using 450 sentences among 503 sentences in the Japanese speech dataset ATR phoneme-balanced sentences (Reference Document 4: Akira Kurematsu, Kazuya Takeda, Yoshinori Sagisaka, Shigeru Katagiri, Hisao Kuwabara, and Kiyohiro Shikano, “ATR japanese speech database as a tool of speech recognition and synthesis,” Speech Communication, vol. 9, no. 4, pp. 357{363, 1990) as training data, and using the remaining 53 sentences as evaluation data.

The speaker of the input voice sequence is each one male “mht” and one female “msh”. The speaker of the target voice sequence are also each one male “fym” and one female “ftk”. The sampling rate of the voice is 16 kHz.

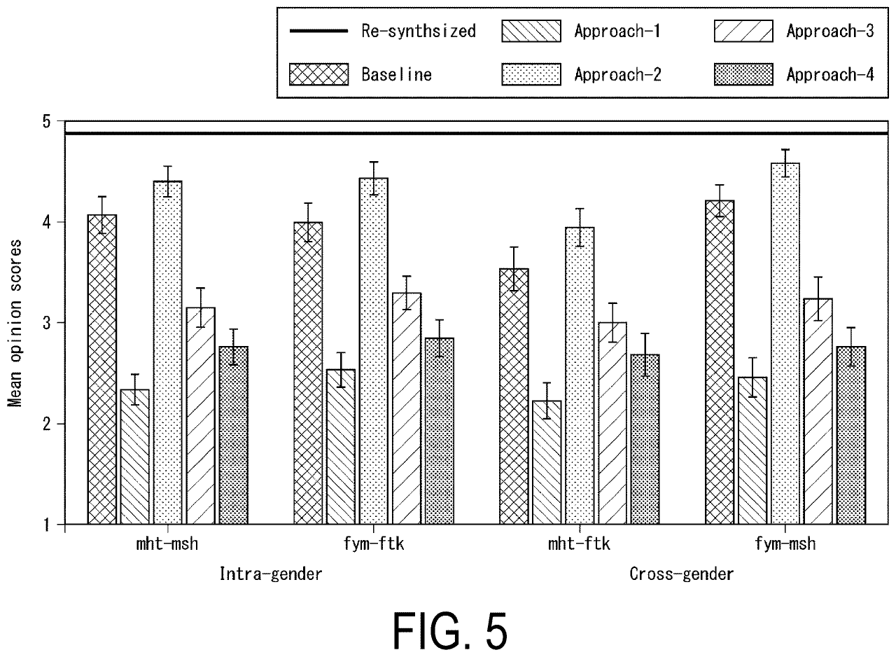

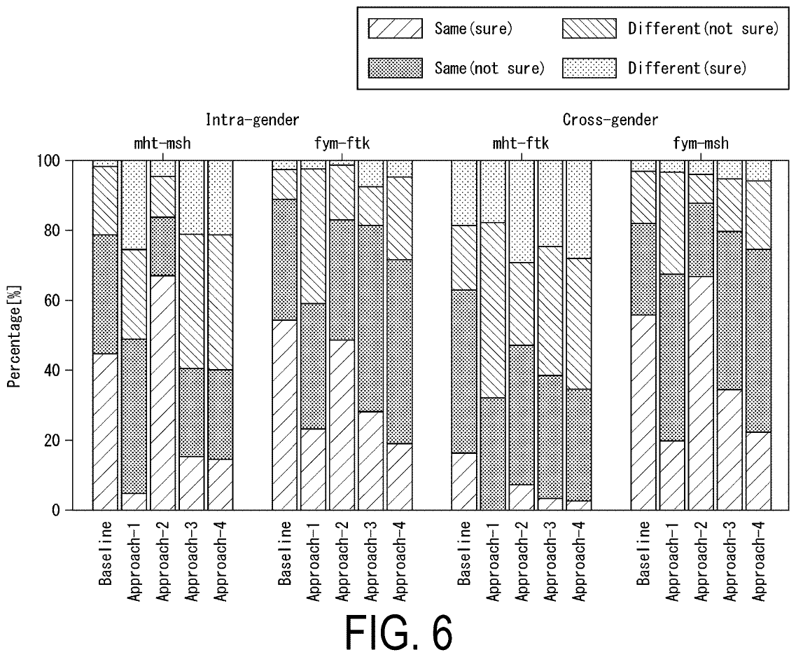

FIG. 5 is a diagram illustrating an example of the subjective evaluation result related to sound quality in each embodiment. Voice quality was evaluated using mean opinion scores (MOSs). The mean opinion score is represented by a five-grade score from the lowest “1” to the highest “5”. As described above, the higher the mean opinion score, the better the voice quality.

The voice quality in the second embodiment is equivalent to the voice quality of the conventional method “Baseline”. Note that the respective voice qualities in the first embodiment, the third embodiment, and the fourth embodiment are also sufficiently high.

FIG. 6 is a diagram illustrating an example of the subjective evaluation result related to speaker similarity in each embodiment. Speaker similarity was evaluated using the Preference Test (PT). The scores of the preference test are expressed by four grades of “1” for a case of being different and sure, “2” for a case of being different and not sure, “3” for a case of being same and not sure, and “4” for a case of being same and sure. As described above, the higher the score of the preference test, the higher the similarity and the better the performance of the voice conversion.

From these results, in each embodiment, it was shown that it is possible to perform sequential conversion processing on the feature with a low delay while holding the voice quality and the speaker similarity.

### (Hardware Configuration Example)

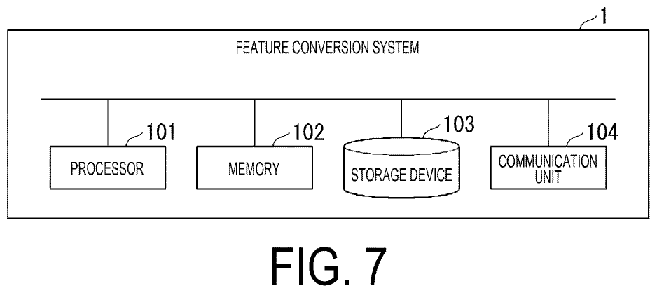

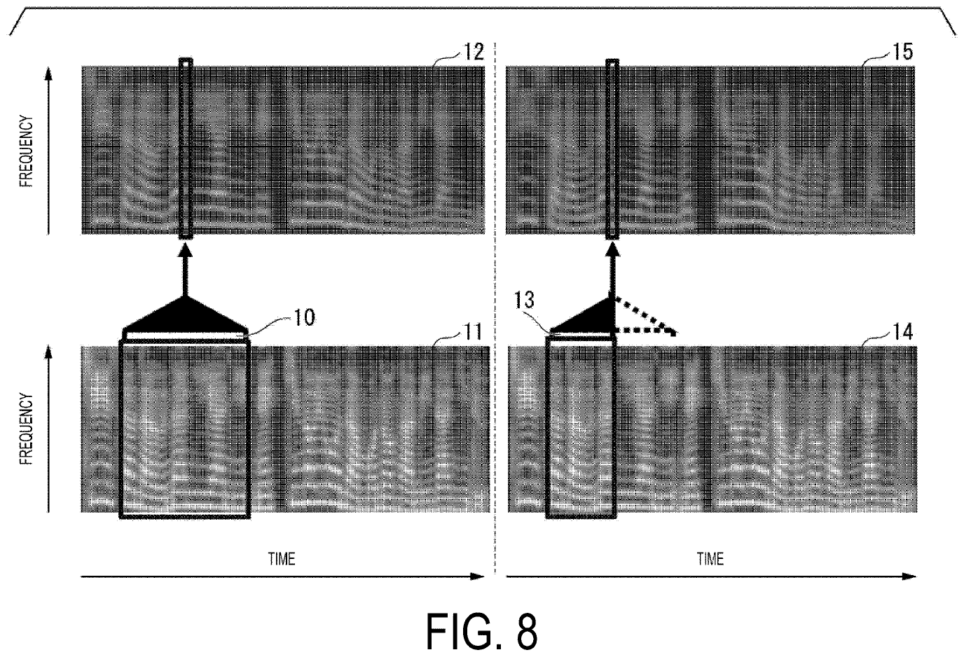

FIG. 7 is a diagram illustrating a hardware configuration example of the feature conversion system 1 in each embodiment. Some or all of the functional units of the feature conversion system 1 are implemented as software by a processor 101 such as a central processing unit (CPU) executing a program stored in a memory 102 and a storage device 103 including a nonvolatile recording medium (non-transitory recording medium). The program may be recorded in a computer-readable non-transitory recording medium. The computer-readable non-transitory recording medium is, for example, a portable medium such as a flexible disk, a magneto-optical disc, a read only memory (ROM), or a compact disc read only memory (CD-ROM), or a non-transitory recording medium such as a storage device such as a hard disk built in a computer system. A communication unit 104 performs a predetermined communication process. The communication unit 104 may acquire data such as a voice signal (waveform signal) and a program.

Some or all of the functional units of the feature conversion system 1 may be implemented using, for example, hardware including an electronic circuit (electronic circuit or circuitry) in which a large scale integrated circuit (LSI), an application specific integrated circuit (ASIC), a programmable logic device (PLD), a field programmable gate array (FPGA), or the like is used.

Although the embodiments of the present invention have been described in detail with reference to the drawings, specific configurations are not limited to the embodiments, and include a design and the like within a range without departing from the gist of the present invention.

### INDUSTRIAL APPLICABILITY

The present invention is applicable to machine learning and a feature conversion system (signal processing system) for converting a feature (for example, the amount related to the speaker properties and the amount related to the speaking style) of a voice or the like.

### REFERENCE SIGNS LIST

1 Feature conversion system
2 Learning device
3 Feature conversion device
4 Vocoder
10 Non-causal layer
11 Input feature sequence
12 Converted feature sequence
13 Causal layer
14 Input feature sequence
15 Converted feature sequence
16 Attention matrix
17 Attention matrix
21 Teacher model unit
22 Student model unit
23 Learning control unit
31 Acquisition unit
32 Converter
101 Processor
102 Memory
103 Storage device
104 Communication unit
211 Teacher encoder
212 Teacher decoder
221 Student encoder
222 Student decoder

1. A learning device comprising:
a teacher model that includes a first encoder and a first decoder including a first recurrent neural network;
a student model that includes a second encoder and a second decoder including a second recurrent neural network; and
a learning controller that performs learning of the teacher model by using a sequence-to-sequence machine learning method and performs learning of the student model by using a knowledge distillation method from the teacher model.

2. The learning device according to claim 1, wherein
the teacher model generates an attention matrix,
the second encoder generates an encoded input feature sequence based on a first speaker vector and an input feature sequence of the speaker of the first speaker vector,
a model parameter of the second decoder is initialized and fixed by a model parameter of the first decoder, and
the second decoder generates a second target feature sequence of a speaker of a second speaker vector based on the second speaker vector, a first target feature sequence of the speaker of the second speaker vector, the attention matrix, and the encoded input feature sequence.

3. The learning device according to claim 1, wherein
the second encoder generates an encoded target feature sequence based on a speaker vector and the target feature sequence of a speaker of the speaker vector,
a model parameter of the second decoder is initialized and fixed by a model parameter of the first decoder, and
the second decoder generates a second target feature sequence of the speaker of the speaker vector based on the speaker vector, a first target feature sequence of the speaker of the speaker vector, and the encoded target feature sequence.

4. The learning device according to claim 1, wherein
the teacher model generates an attention matrix,
the second encoder generates an encoded input feature sequence based on a first speaker vector and the input feature sequence of a speaker of the first speaker vector, and
the second decoder generates a second target feature sequence of a speaker of a second speaker vector based on the second speaker vector, a first target feature sequence of the speaker of the second speaker vector, the attention matrix, and the encoded input feature sequence.

5. The learning device according to claim 1, wherein
the teacher model generates a first attention matrix,
the second encoder generates an encoded input feature sequence based on a first speaker vector and the input feature sequence of a speaker of the first speaker vector,
the second decoder generates a second target feature sequence of a speaker of a second speaker vector and a second attention matrix based on the second speaker vector, a first target feature sequence of the speaker of the second speaker vector, and the encoded input feature sequence, and
the learning controller obtains a loss based on the first attention matrix and the second attention matrix.

6. A feature conversion device comprising:
an acquirer that acquires a student model from a learning device including a teacher model that includes a first encoder and a first decoder including a first recurrent neural network, the student model that includes a second encoder and a second decoder including a second recurrent neural network, and a learning controller that performs learning of the teacher model by using a sequence-to-sequence machine learning method and performs learning of the student model by using a knowledge distillation method from the teacher model; and
a converter that converts an input feature sequence into a target feature sequence using the student model.

7. A learning method performed by a learning device, the learning method comprising:
performing learning of a teacher model that includes a first encoder and a first decoder including a first recurrent neural network by using a sequence-to-sequence machine learning method; and
performing learning of a student model that includes a second encoder and a second decoder including a second recurrent neural network by using a knowledge distillation method from the teacher model.

8. (canceled)
